(19) United States
(12) Patent Application Publication
(10) Pub. No.: US 2017/0015210 A1
(43) Pub. Date: Jan. 19, 2017

(54) CHARGE PRIORITIZATION TO MANAGE PEAK LOADS

(71) Applicant: EV Connect, Inc., El Segundo, CA (US)

(72) Inventors: Brad Juhasz, Glendale, CA (US); Gus Eleopoulos, Long Beach, CA (US); Gavin Minami, Los Angeles, CA (US)

(21) Appl. No.: 14/797,976

(22) Filed: Jul. 13, 2015

(51) Int. Cl. B60L 11/18

(52) U.S. Cl. CPC B60L 11/1844; B60L 11/1846; B60L 11/1848

(57) ABSTRACT

An electric vehicle charging system includes multiple electric vehicle charging stations, each suitable for charging at least one electric vehicle, and a computing device. The computing device is for determining that a present load exceeds a predetermined peak load, the present load made up of the combined present loads of the multiple electric vehicle charging stations, identifying at least two of the multiple electric vehicle charging stations for adjustment of an electrical load, and adjusting the electrical load of the at least two of the multiple electric vehicle charging stations to arrive at an adjusted load across the multiple electric vehicle charging stations, such that the adjusted load is less than the predetermined peak load.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

Field

This disclosure relates to the management of electric vehicle charging stations queues.

Description of the Related Art

The owners of plug-in electric and hybrid electric vehicles, which will be referred to herein as PEVs, typically have a dedicated charging station at the home or other location where the vehicle is normally garaged. However, without the existence of an infrastructure of public charging station, the applications for PEVs will be limited to commuting and other short-distance travel. In this patent, a charging station is considered “public” if it is accessible and usable by plurality of drivers, as opposed to a private charging station located at a PEV owner's home. A “public” charging station is not necessarily accessible to any and all PEVs. Public charging stations may be disposed, for example at commercial buildings, shopping malls, multi-unit dwellings, governmental facilities and other locations.

In the U.S., charging stations usually comply with the Society of Automotive Engineers (SAE) standard, SAE J1772™. This standard refers to charging stations as “electric vehicle support equipment”, leading to the widely used acronym EVSE. However, since the only support actually provided by an EVSE is charging, this patent will use the term electrical vehicle charging station or EVCS.

Some workplaces, municipalities, and public spaces provide access to a large number of EVCS. For example, a city may have twenty EVCS in each city-run garage or parking lot and may operate a series of 10-15 garages and parking lots. As a result, the city may offer a total of 200 EVCS to electric vehicle operators spread across several physical locations.

The rates charged by electric power companies to all electricity users, but for purposes of this patent particularly to operators of EVCS charging stations, tend to be highest mid-day. While individuals are working, air conditioners operate throughout commercial spaces, computers of many employees operate, and internal lighting is used in commercial spaces. Because the overall electrical draw is highest during the workday, electric power companies charge higher rates during the work-day to discourage wasteful usage.

### DESCRIPTION OF THE DRAWINGS

FIG. 1 is a block diagram of an environment for charging an electric vehicle.

FIG. 2 is a block diagram of an electric vehicle charging station (EVCS) cloud.

FIG. 3 is a block diagram of a computing device.

FIG. 4 is a block diagram of an EVCS.

FIG. 5, made up of FIGS. 5A and 5B, shows EVCS electrical panels. FIG. 5A is a single phase panel. FIG. 5B is a three phase panel.

FIG. 6 is a block diagram of a personal computing/communications device.

FIG. 7 is a flowchart of the input of a new throttle rule into an EVCS cloud.

FIG. 8 is a rule input matrix.

FIG. 9 is a flowchart of the process of multiple EVCS load adjustment.

FIG. 10 is a flowchart of prioritization of EVCS for use in identifying EVCS for load adjustment.

FIG. 11 is a prioritization matrix for use in prioritizing vehicles across multiple EVCS.

FIG. 12 is a prioritization matrix showing priority for vehicles.

FIG. 13 is a flowchart for load sharing on single or multi-phase EVCS panels.

FIG. 14, made up of FIGS. 14A and 14B, shows calculations related to load sharing. FIG. 14A is a table showing calculations related to particular legs being shared, where FIG. 14B is a table showing the throttle applied to each bridged leg based upon the calculations of FIG. 14A.

Throughout this description, elements appearing in figures are assigned three-digit reference designators, where the most significant digit is the figure number where the element is introduced and the two least significant digits are specific to the element. An element that is not described in conjunction with a figure may be presumed to have the same characteristics and function as a previously-described element having the same reference designator.

### DETAILED DESCRIPTION

Because costs associated with electricity are highest during mid-day and because peak loads are most likely to be reached mid-day, companies and governments that offer electric vehicle charging may wish to maintain the peak load below a certain load threshold. There are many options for ensuring that a peak load of a predetermined threshold is not met. For example, individual EVCS may be disabled completely, EVCS may be throttled, and individuals or groups may be prioritized for charging or for not being throttled as these decisions are made. Granular control may be preferred or management of entire EVCS systems may be preferred in order to ease in overall control. As used herein “throttle” or past means to instruct an EVCS to reduce the amperage available to a PEV to thereby lower the overall draw from the EVCS by a PEV. A throttle may be to an EVCS as a whole (all PEVs connected thereto) or may be to an individual PEV connected to the EVCS with others remaining unaffected.

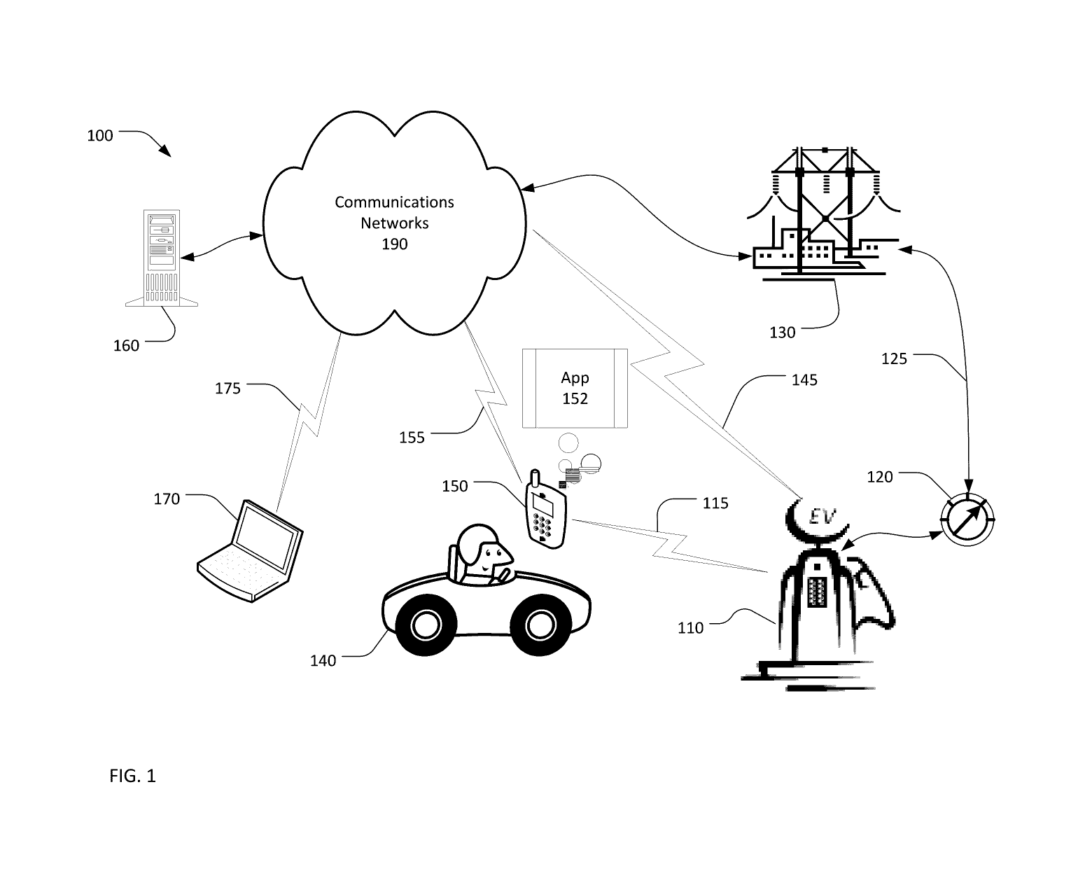

Referring now to FIG. 1, an environment 100 for charging an electric vehicle 140 may include an EVCS 110 connected to a utility grid 130 via a meter 120. The EVCS 110 may communicate with a driver's personal communications device (PCD) 150 over a first wireless communications path 115. In some cases, the PCD 150 may be integrated into the electric vehicle 140. In such cases, the EVCS 110 may communicate directly with the electric vehicle 140, either wirelessly or via a connection integrated into the electrical connection to the EVCS 110.

The PCD may, in turn, connect to a network 190 over a second wireless communication path 155. The first wireless communications path 115 may use, for example, Bluetooth™, ZigBee™, or some other short-range wireless communications protocol. The second communications path 155 may use, for example, WiFi™ or a cell phone data communications protocol to connect to the network 190. The PCD 150 may be, for example, a smart phone, a tablet computer, a laptop computer, a computer operating as a part of the PEV or some other device capable of communicating with the EVCS 110 and the network 190.

The PCD 150 may run or access an application, or “app”, 152 that enables the PCD to serve as a user interface for the EVCS 110. This app 152 may be web-based or compiled for use on the PCD. The EVCS 110 and the network 190 may communicate using a third communications path 145. This third communications path 145 may be wireless, as described above, or wired. If the third communications path 145 is wired, it may rely upon proprietary protocols or protocols based upon the OSI model. In some situations, the PCD 150 running the app 152 may also function as a bridge to provide bidirectional communications between the EVCS 110 and the network 190.

A server 160 may manage a network of vehicle charging stations including the EVCS 110. The server 160 may monitor the operation of the EVCS 110. The server 160 may manage billing and/or cost allocation for the use of the EVCS 110. The server 160 may manage an authorization system to limit access to the EVCS 110 to only authorized vehicles or drivers. The server 160 may also manage a reservation or queue system to allow authorized drivers to reserve future use of the EVCS 110. The server 160 may communicate with the EVCS 110 via the network and the third communications path 145. The server 160 may communicate with the EVCS 110 via the network and the PCD 150. In this case, communications between the server 160 and the EVCS 110 may be intermittent and only occur when a PCD 150 running the app 152 is present.

The server 160 may also communicate with the PCD 150 directly to pass messages to a driver or operator of a PEV. A driver may communicate with the server 160 using their PCD 150 or using another computing device such as a personal computer 170 coupled to the network 190 by a wired or wireless communications path 175. The driver may communicate with the server 160, for example, to establish an account, to provide billing information, to make a reservation, or for some other purpose. The server 160 may communicate with the PCD 150 in order to provide messages, such as EVCS 110 availability, non-availability, rates charged for access to the EVCS 110, requests to move a PEV to or from the EVCS 110, indications that charging has begun or completed, and other, similar messages.

The meter 120 may be a conventional electric utility meter or a so-called “smart meter” that communicates, via a network 125, with the utility grid 130 and the EVCS 110. The EVCS 110 may communicate with a smart meter 120, when present, using the same wireless protocol used to communicate with the PCD 150 or a different wireless communications protocol. The EVCS may communicate with the smart meter 120 using a power line communications (PLC) protocol such as, for example, the IEEE 1901 protocol.

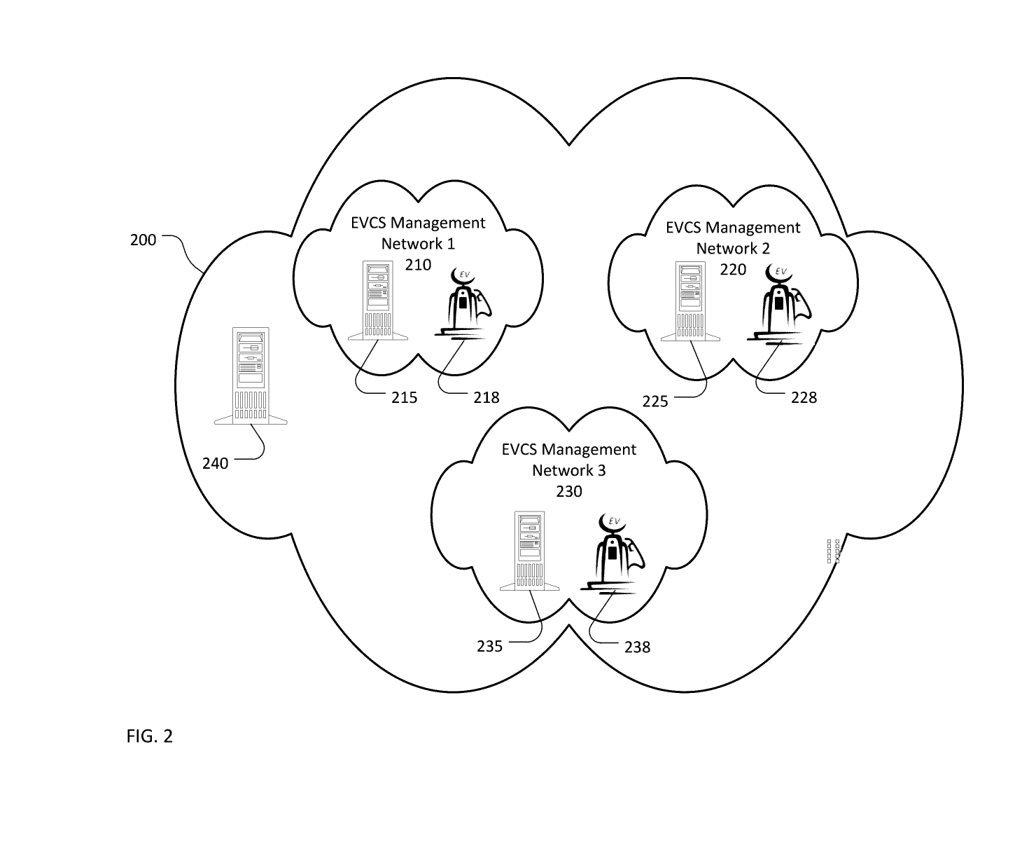

Referring now to FIG. 2, a cloud 200 may support a plurality of EVCS management networks, each of with may operate, for example, as a part of a virtual private network within the cloud 200. Three EVCS management networks 210, 220, 230 are shown in this example. Each EVCS management network 210, 220, 230 may include a respective server 215, 225, 235 to manage access, billing, and queuing for the one or more EVCS within the network. Each of these servers 215, 225, 235 may be substantially the same as EVCS server 160 (FIG. 1).

A cloud 200 may contain more or fewer than three EVCS management network. Each of the EVCS management networks 210, 220, 230 may be owned or operated by different the same or different entities such as, for example, municipalities, corporate entities, electric utility companies, or manufacturers of EVCS equipment. Each EVCS management network 210, 220 and 230 may serve one or more EVCS 218, 228, 238 operating at respective locations. These locations may be immediately adjacent to one another (e.g. within the same parking lot or physical location) or may be physically distinct from one another, separated by tens, hundreds, or thousands of miles. The cloud 200 may include a physical or virtual server 240 to manage the EVCS management networks 210, 220, 230 and interactions between them and with drivers of PEVs interfacing with the EVCS serviced by each of the EVCS management networks 210, 220, 230.

The server 240 may communicate with each of the EVCS management networks 210, 220, 230. The server 240 may manage transactions between the EVCS management networks 210, 220, 230. Further, the server 240 may manage interactions with drivers of PEVs across all of the EVCS management networks 210, 220, 230. For example, server 240 may provide a unified billing and payments structure for access to the EVCS served by the server 240. Similarly, particularly in cases when each of the EVCS management networks 210, 220, 230 are managed by the same entity, the billing structure, authorized access lists, and priority may be maintained collectively by the server 240 for all of the EVCS management networks 210, 220, 230. Similarly, the server 240 may implement a prioritization scheme or throttle individual or groups of EVCS as directed by an administrator.

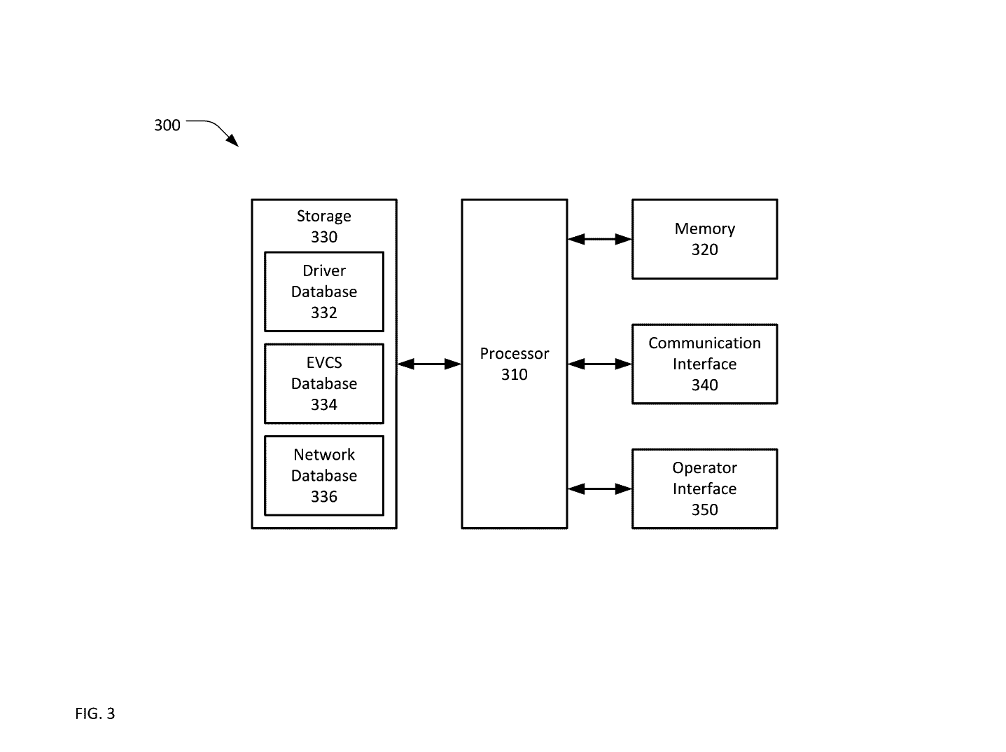

Turning now to FIG. 3, a block diagram of a computing device 300 is shown. The computing device 300 may be, for example, the server 160 of FIG. 1 or one of the servers 215, 225, 235 or 240 of FIG. 2. The computing device 300 includes a processor 310, memory 320, storage 330, a communication interface 340 and an operator interface 350. The storage 330 includes a driver database 332, an EVCS database 334 and a network database 336.

The processor 310 may include hardware, which may be augmented by firmware, for providing functionality and features described herein. The processor 310 may include one or more processor circuits such as microprocessors, digital signal processors, and graphic processors. The processor 310 may include other circuits such as logic arrays, analog circuits, and/or digital circuits.

The memory 320 may include static or dynamic random access memory, read-only memory, and/or nonvolatile memory such as flash memory. Information stored in the memory may include a BIOS (basic input/output system) to initialize the processor 310, along with other data relating to ongoing operation of the processor 310.

The storage 330 may include one or more storage devices. As used herein, a “storage device” is a device that allows for reading and/or writing to a storage medium. These storage media include, for example, magnetic media such as hard disks, optical media such as compact disks (CD-ROM and CD-RW) and digital versatile disks (DVD and DVD±RW); flash memory devices; and other storage media. As used herein, the term “storage media” means a physical object for storing information. The term storage media does not encompass transitory media such as signals and waveforms.

Information stored in the storage 330 may include a driver database 332. The driver database 332 may contain information pertaining to drivers (or operators) of PEVs that may access the computing device 300 or an associated EVCS. The driver database 332 may include information, for each driver, such as a user name or other unique identification, an associated password, address information, billing information, a driver's real name, a driver's email address, a driver's mobile telephone number and a preferred method of contact.

Information pertaining to a particular driver's vehicle may also be stored in the driver database 332. This information may include a make of a driver's PEV, a model of a driver's PEV, a year of manufacture of a driver's PEV, a battery size of a driver's PEV, whether a driver's PEV is electric-only or a plug-in hybrid, a commute distance from an electric vehicle charging station to a PEV driver's home (or a home location from which such data may be derived), additional distances travelled by the PEV driver on a regular basis, a typical arrival time of a driver's PEV, a typical departure time of a driver's PEV, a present state of charge for a driver's PEV (if available, for example through reporting protocols that communicate directly with an EVCS as a vehicle charges), a present rate of charge for a driver's PEV (if available), a PEV driver's association with an account indicating membership in a special group, and a PEV driver's association with an account willing to pay additional fees for continued electric vehicle charging. A special group may be, for example, an employee or an executive at an entity.

The storage 330 may include an EVCS database 334. The EVCS database 334 may contain information pertaining to each of the EVCS that are serviced by the computing device 300. For example, in FIG. 2, each server 215, 225, 235 managed one or more EVCS within a respective EVCS management network 210, 220, 230. The EVCS database 334 may store information pertaining to the network address (if any) of each EVCS under its service, the capabilities of each EVCS, the present electrical load on each of the EVCS, the present and projected use of each EVCS, any queue of users wishing to access each EVCS (in some cases a group of EVCS may be managed under a single queue, for example, at a location including multiple EVCS), the PEV (and associated driver) presently using each EVCS and any other information pertaining to each EVCS.

The storage 330 may include a network database 336 in addition to or instead of the driver database 332 and/or the EVCS database 334. The network database 336 may include data pertaining to communicating and managing transactions with one or more EVCS networks. The network database 336 may maintain authentication or other information necessary to enable this access. For example, the server 240 in FIG. 2 may include a network database containing information necessary to manage transactions between the EVCS management networks 210, 220, 230. The server 240 may not contain a driver database and/or an EVCS database since the server 240 may rely upon the servers 215, 225, and 235 within the respective EVCS networks to store driver and EVCS information.

Information stored in the storage 330 may also include program instructions for execution by the processor 310. The program instructions may be in the form of an application program, an applet (e.g., a Java applet), a browser plug-in, a COM object, a dynamic linked library (DLL), a script, or one or more subroutines. The program instructions may include an operating system such as, for example, variations of the Unix, Linux, Microsoft Windows®, Symbian®, Android®, and Apple® operating systems.

The communication interface 340 may include specialized circuits required to interface the computing device 300 with, for example, a network such as network 190 in FIG. 1, a PCD or a PEV. The communication interface 340 may include interfaces to one or more wired or wireless networks. The communication interface 340 may include, for example, one or more of an Ethernet™ interface for connection to a wired network, a Bluetooth™ transceiver, a Zigbee™ transceiver, a WiFi™ transceiver, and/or a transceiver for some other wireless communications protocol. The communication interface 340 may be used to communicate information to and/or to receive information from a PCD or with a PEV that is or will be using an EVCS.

The operator interface 350 is used for an operator of the computing device 300 to interact with and to operate the computing device 300. The operator interface 350 may include a color or black-and-white flat panel display, such as a liquid crystal display, and one or more data entry devices such as a touch panel, a keyboard, and/or a mouse or other pointing device. Alternatively, the operator interface 350 may use the communications interface 340 in order to interact with an external PCD or web browser to provide some or all of the functionality provided by a direct user interface.

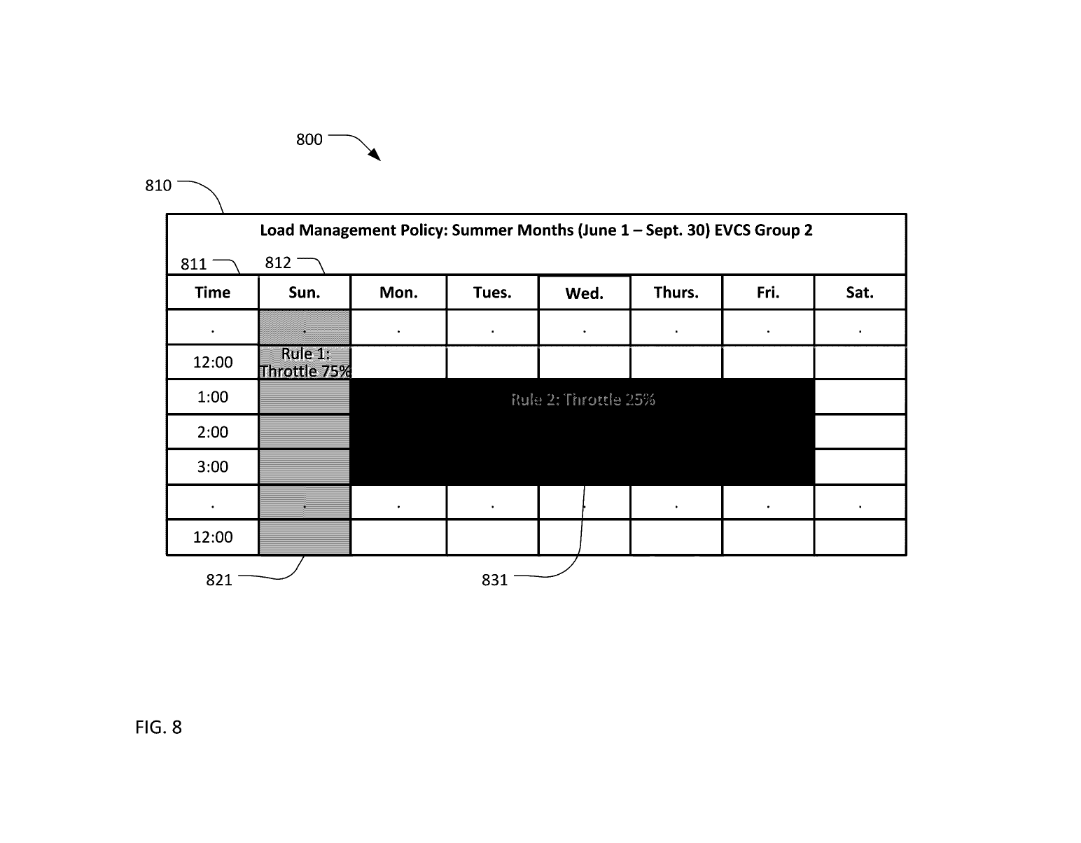

For example, the operator interface 350 and communications interface 340 may work to create, either directly on a server 200, or on a remote server, a web interface that may be used by an administrator to control the operation of one or more EVCS. FIG. 8, for example, is one portion of a web-based interface that may be used by an administrator to control one or more EVCS. Although described as “web-based” the interface may be or appear as an application or mobile “app,” for example operating on a client computer or a mobile device such as a smart phone or tablet.

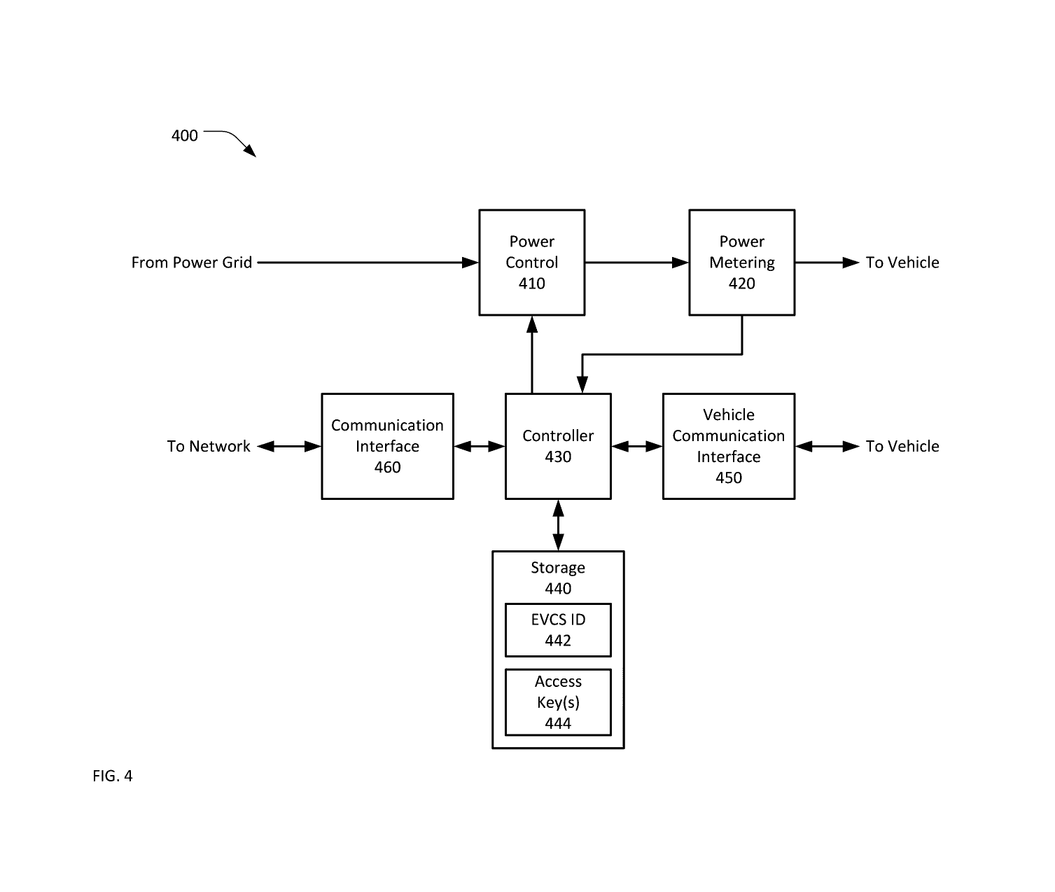

Referring now to FIG. 4, a block diagram of an EVCS 400 is shown. The EVCS may include power control 410, power metering 420, a controller 430, storage 440, a vehicle communication interface 450, and a communication interface 460. The storage 440 may store data including an EVCS ID 442 and access key(s) 444.

The power control 410 handles the receipt of power from the power grid by the EVCS 400. The power control 410 is instructed by the controller 430 to direct power through the power metering 420 to a vehicle being charged by the EVCS 400. The power control 410 may be, for example, a relay or solid-state switch to either turn on or turn off the charging power to the vehicle in response to an instruction from the controller 430. The power metering 420 measures the current passing through the power control and accumulates the total charge or energy delivered from the EVCS 400 to the vehicle. This power metering 420 may be used in determining the appropriate cost to the operator of the vehicle.

The controller 430, which may be or include a computing device including one or more processors and memory, may communicate with vehicles, such as a PEV, using the vehicle communication interface 450. The vehicle communication interface 450 may, for example, provide a pilot line signal to the PEV in accordance with SAE J1772™. The vehicle communication interface 450 may communicate with vehicles in some other manner such as power line communications or wirelessly. Through the vehicle communication interface 450, the controller 430 of the EVCS may receive information from the vehicle indicating the present charge state of a PEV and a rate at which that charge state is changing. As a result, the controller 430 may be able to estimate a time-to-full charge state.

The communication interface 460 may be used to communicate with the network and, by extension, with an EVCS server, such as the servers 215, 225, 235, in an EVCS network that includes the EVCS 400. The communication interface 460 may communicate with the network by way of a wired connection, such as an Ethernet connection. The communication interface 460 may communicate with the network by a wireless connection such as a WiFi™ local area network or a cellular telephone connection. The communication interface 460 may communicate with the network directly or indirectly by way of a wireless connection to a driver's smart phone or other personal communication device. For example, the communication interface 460 may utilize wireless connectivity available to a driver's PCD, while the PCD is within range of the EVCS 400, to access one or more networks. The communication interface 460 may enable access data and other data from a PCD or PEV to be shared with an EVCS server and to enable receipt of commands to the EVCS to enable charging, disable charging, or otherwise interact with a PEV or a driver of a PEV (for example via a communication to a PCD).

The controller 430 may use the communication interface 460 to obtain data pertaining to drivers of PEVs, to obtain access to a queue of potential EVCS users, to access a list of authorized EVCS users, to transmit data pertaining to use of the EVCS by particular drivers and/or PEVs, and/or to communicate driver and billing information. For example, the EVCS may communicate to an EVCS server that the EVCS is no longer in use by the most recent driver. The EVCS 400 may use the communication interface 460 to notify the next driver, such as through simple message service or email, that the EVCS 400 is available for his or her use. Similarly, the EVCS server may send such a notification in response to the EVCS communicating that the EVCS 400 is no longer in use. Alternatively, the EVCS server may send a notification indicating that, due to a determination of priority, a particular PEV is no longer drawing a charge.

The EVCS 400 also includes storage 440. The storage 440 provides nonvolatile storage of program instructions and data for use by the controller 430. Data stored in the storage 440 may include an EVCS ID 442. The EVCS ID 442 may be a unique identifier that is used to uniquely identify each EVCS in an EVCS network. The EVCS ID 442 may be, for example, a serial number, a MAC address, some other similar unique identifier, or a combination of two or more identifiers. The EVCS ID 442 may be derived by encrypting a serial number, a MAC address, some other unique identifier, or a combination of two or more identifiers. The EVCS ID 442 may be a random number or other identifier assigned by a remote device such as a server that manages an EVCS network containing the EVCS 400. The controller 430 may use the EVCS ID to uniquely identify the EVCS 400 to the network and/or PEVs using the communication interface 460 and the vehicle communication interface 450, respectively.

The access key(s) 444 may include one or more keys used by an administrator or maintenance personnel to, either remotely or directly at the EVCS 400, access maintenance and administrative features for the EVCS 400. For example, an administrator may be required to input an access key 444 in order to access administrator functions for the EVCS 400. In addition, the storage 440 may store software suitable to perform the various functions of the EVCS 400 described herein. The storage 440 may also store data pertaining to usage of various PEVs and associated users such that billing may be properly reported to, for example, an EVCS server.

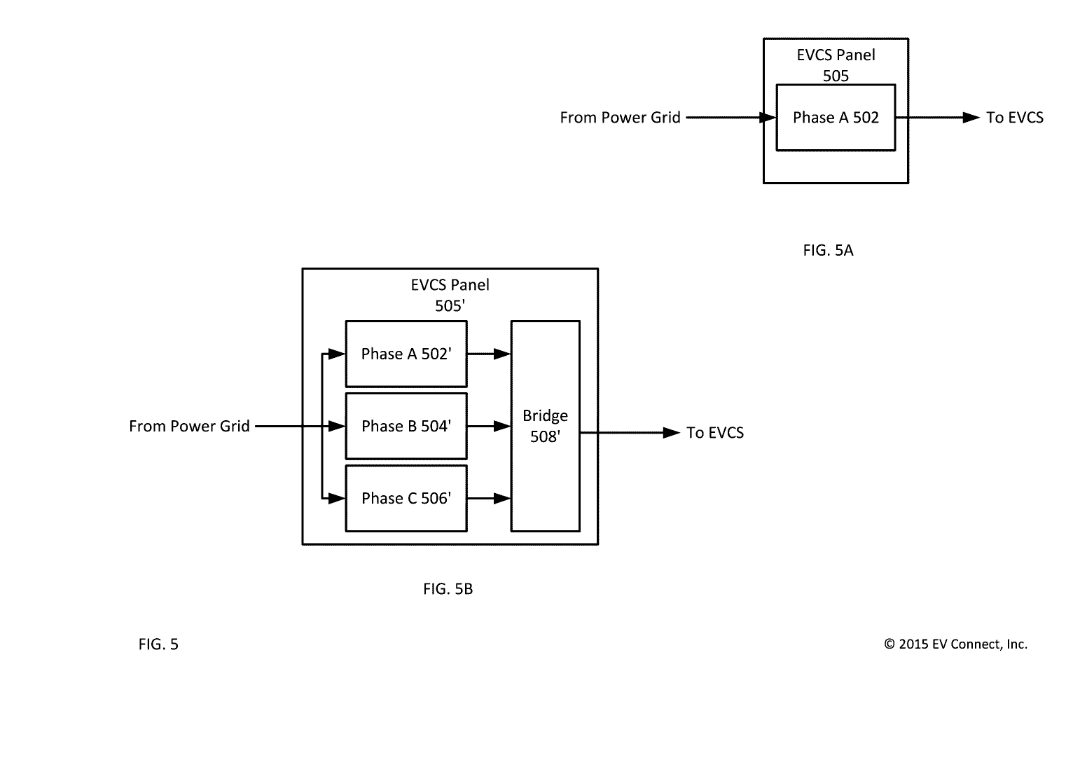

FIG. 5, made up of FIGS. 5A and 5B, shows EVCS electrical panels. FIG. 5A is a single phase panel. FIG. 5B is a three phase panel. The panel is preferable separate from the EVCS itself, but in some cases may be integrated into the overall physical structure of an EVCS.

Turning first to FIG. 5A, the single phase panel 505 is shown with power from the power grid entering the single phase A 502. The panel may, therefore, provide a single circuit, based the single phase A 502 to a connected EVCS.

Turning to FIG. 5B, a three phase panel, a series of phases are provided by the EVCS panel 505′ based upon power received from the power grid. These are shown as phases A 502′, B 504′ and C 506′. The phases may be joined, when desired by a connecting EVCS, using a bridge like bridge 508′. The bridge 508′ may in fact be multiple bridges that operate only on specific legs such as leg AB, leg BC, and leg CA. However, more sophisticated bridges, such as software controlled bridges, may simultaneously interact with each of the phases A 502′, B 504′, and C 506′ to bridge legs in groups of two as desired. The bridged circuits can provide additional power or throughput to an EVCS which may connect one or more PEVs for charging.

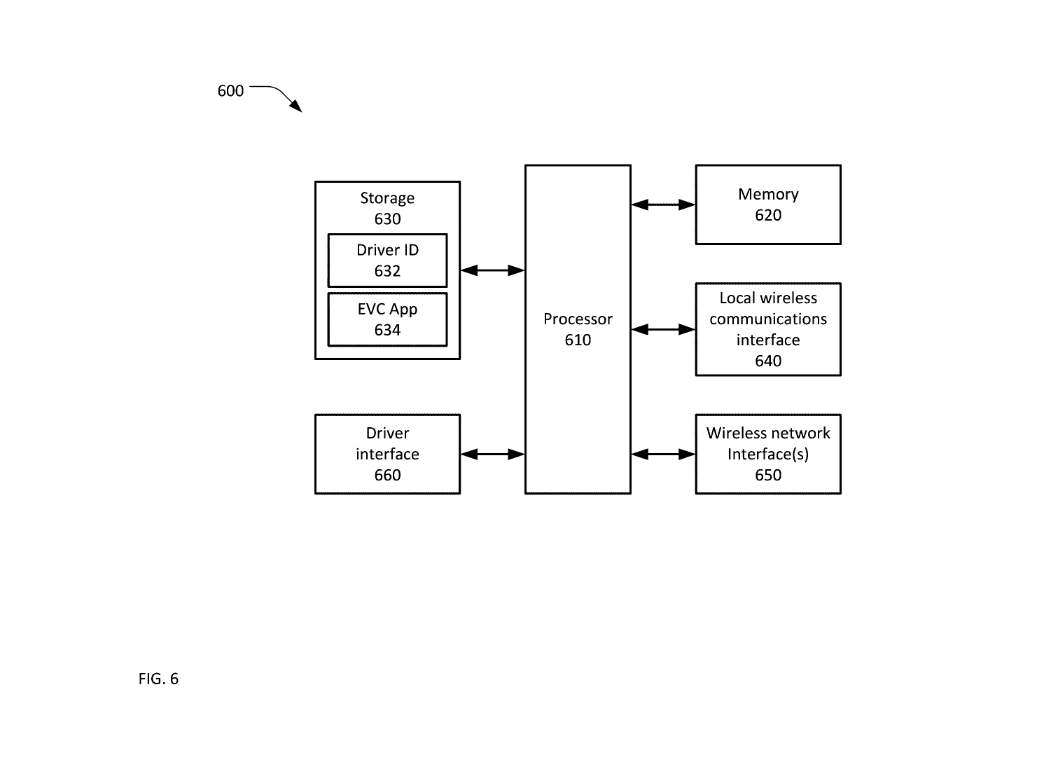

FIG. 6 shows a block diagram of a personal computing/communications device 600 (a “PCD”). The PCD 600 includes a processor 610, memory 620, storage 630, local wireless communications interface 640, wireless network interface(s) 650 and a driver interface 660. The driver interface 660 may be, for example, a touch screen display or some other combination of a display and a data input device such as a keypad and/or a pointing device.

The local wireless communications interface 640 may be, for example, a Bluetooth™, Zigbee™ or wireless local area network interface that can connect within a short distance of the PCD 500. This local wireless communications interface 540 may be used, for example, to connect to an EVCS, such as the EVCS 400, in order to exchange data pertaining to the EVCS.

The wireless network interface(s) 650 may be one or more interface usable to send and receive data over a long-range wireless communication network. This wireless network may be, for example, a mobile telephone network with data capabilities and/or a WiFi™ local area network or other wireless local area network.

The processor 610 and memory 620 serve substantially similar functions to the processor 310 and memory 320 in FIG. 3. The storage 630 may serve substantially similar functions to the storage 330 in FIG. 3. The storage 630 may store a driver ID 632 and an electric vehicle charging application (EVC App) 634.

The driver ID 632 may be, for example, provided by an EVCS server or related web-based software. The driver ID 632 uniquely identifies the operator of the PCD 600 to an EVCS. The driver ID 632, therefore, may be used to enable EVCS charging to an intended operator of the PCD 600 and may enable billing for EVCS services to the correct individual. The driver ID 632 may be transmitted to an EVCS (to be forwarded on by the EVCS to an EVCS server) using the wireless network interface(s) 650.

When executed, the EVC App 634 may cause the PCD 600 to serve as an interface between the driver and the EVCS. For example, the EVC App may cause a graphical user interface (GUI) for the EVCS to be presented on the driver interface 660. The driver may then use the GUI to request charging services from the EVCS. The EVC App 634 may also cause the PCD to provide the charging service request, the driver ID 632 and an EVCS access key to the EVCS using either the local wireless communications interface 640 or a wireless network interface 650.

Description of Processes

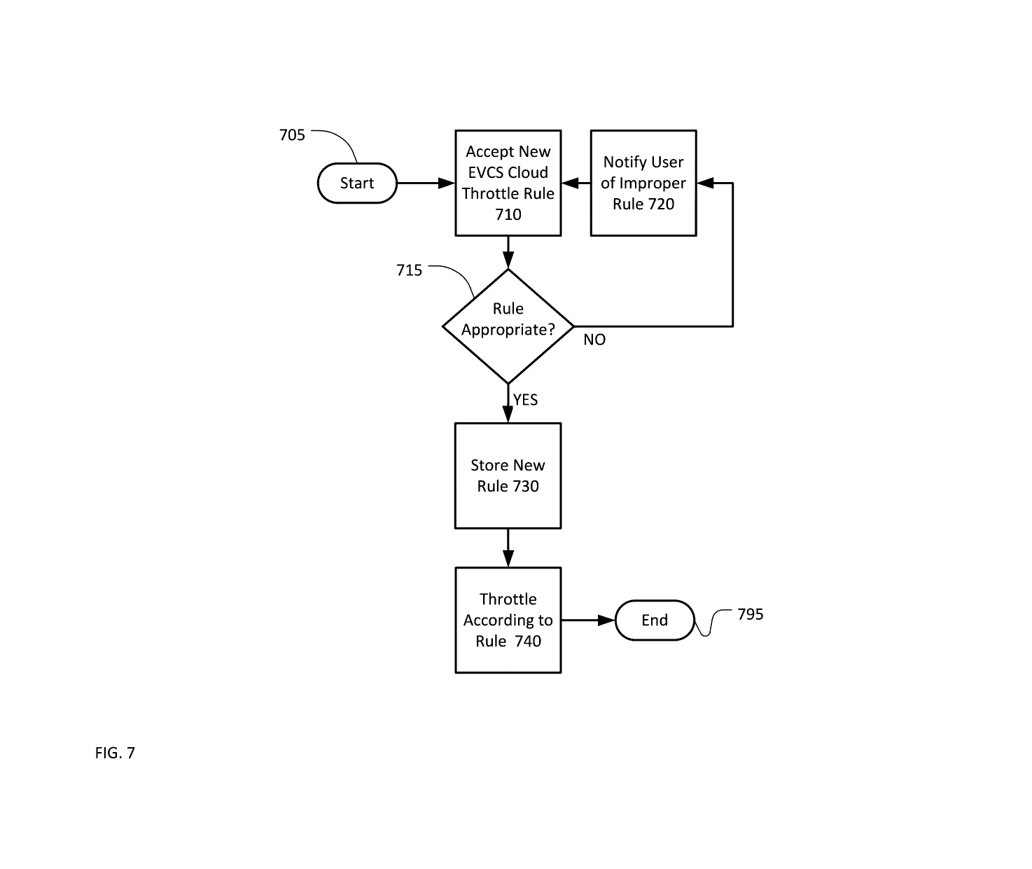

Turning to FIG. 7, a flowchart of the input of a new throttle rule into an EVCS cloud 200 is shown. A throttle rule is a rule for lowering the amperage available to PEVs using one or more EVCS. The process is shown with a start 705 and an end 795, but may operate on an as-needed basis as instantiated by an administrator of an EVCS or EVCS cloud.

After start 705, a new EVCS cloud throttle rule is accepted at 710. This rule may be input, for example, by an administrator at a personal computer or a PCD for an EVCS cloud. The rule may be EVCS cloud-wide covering every EVCS managed by a particular administrator or may apply to a subset of the EVCS cloud such that the rule only applies to certain EVCS.

The throttle rule accepted at 710 may specify a time frame and a day or date range during which the rule will be active. For example, the time frame may be mid-day, from 1:00 pm to 3:00 pm (e.g. Rule 2 831 in FIG. 8). As also shown in FIG. 8, the date range may be, for example, June 1 to September 30 or any number of other date ranges. For example, on days when a business or municipality that uses the EVCS cloud is on holiday, the EVCS cloud may be throttled or, potentially, throttled completely such that the associated EVCS are effectively disabled.

After a rule is input at 710, a determination is made (e.g. by the server 240) whether the rule accepted is appropriate at 715. A rule may be inappropriate because it conflicts with another rule, overlaps with a prior time-frame or date range, or the rule may be invalid as incompatible with one or more EVCS to which the rule is intended to apply.

For example, an existing rule may require throttling to 25% of maximum current on Mondays from 1:00 pm to 3:00 pm. A newly-input rule may require all of Monday to be throttled to 75%. This rule may conflict because there would then be two different throttle percentages for Monday from 1:00 pm to 3:00 pm. Alternatively, the system may include logic regarding additive rules such that it can throttle all of Monday to 75% with the specific time-frame further throttled to 25%.

By way of another example one or more EVCS in a given EVCS cloud may be incapable of throttling. A rule that requires throttling that EVCS (amongst many others) may be inappropriate (at 715) because it is not capable of being carried out. Such a rule may be rejected as inappropriate (“no” at 715). If a rule is rejected at 715 (“no”), the system may notify a user of the problem at 720 and, may request input of a revised rule.

If a rule is appropriate (“yes” at 715), then the new rule may be stored at 730. This storage may take place on the server 240 and may, in some cases, be transmitted to each individual EVCS that is a part of an EVCS cloud for storage thereon. In that case, each EVCS may be aware of its own throttling rules and responsible for implementing them, rather than being dependent upon a single server to actively control the throttling of a large number of EVCS from a central location.

After the rules are stored, the rule is used to throttle identified EVCS according to the rule at 740. As indicated above, multiple rules may be in effect simultaneously.

Referring now to FIG. 8, a FIG. 8 is a rule input matrix 800 is shown. This rule input matrix 800 may be the way in which rules that have been input are shown to an administrator, for example, on an administration web page associated with review or input of rules. Similarly, the rule input matrix 800 may be the way in which new rules are added, by interacting with a finger (on a touchscreen) or a mouse and cursor (on a non-touch-enabled computer screen) to select a series of dates, days, and times during which a particular rule will apply. After the dates, days, and times are selected; the throttle amount may be input, for example, as a percentage of 100%. Alternatively, in some embodiments, the throttle amount may be input as a predetermined peak load across all associated EVCS for an EVCS cloud.

In the rule input matrix 800, the title 810 provides information regarding the particular matrix being shown. This rule input matrix 800 is for the summer months form June 1, to September 30 for an EVCS group 2. The EVCS groups may be managed such that EVCS in a few locations may be managed simultaneously while others utilize a different set of rules. In this way, administrators may actively manage down to the individual EVCS, but may also manage large numbers of EVCS, including all EVCS available in an EVCS cloud with one set of rules.

The time 811 appears down the side of the matrix 800 with the days 812 appearing along the top. In the rule input matrix 800 shown, Rule 1 821 mandates a throttle of 75% for the entire day on Sunday during this date range for EVCS Group 2. Rule 2 831 indicates that a 25% throttle will be applied from 1:00 pm to 3:00 pm, Monday through Friday, for EVCS Group 2. Other EVCS groups and other times and dates may have still other rules not shown in this matrix 800.

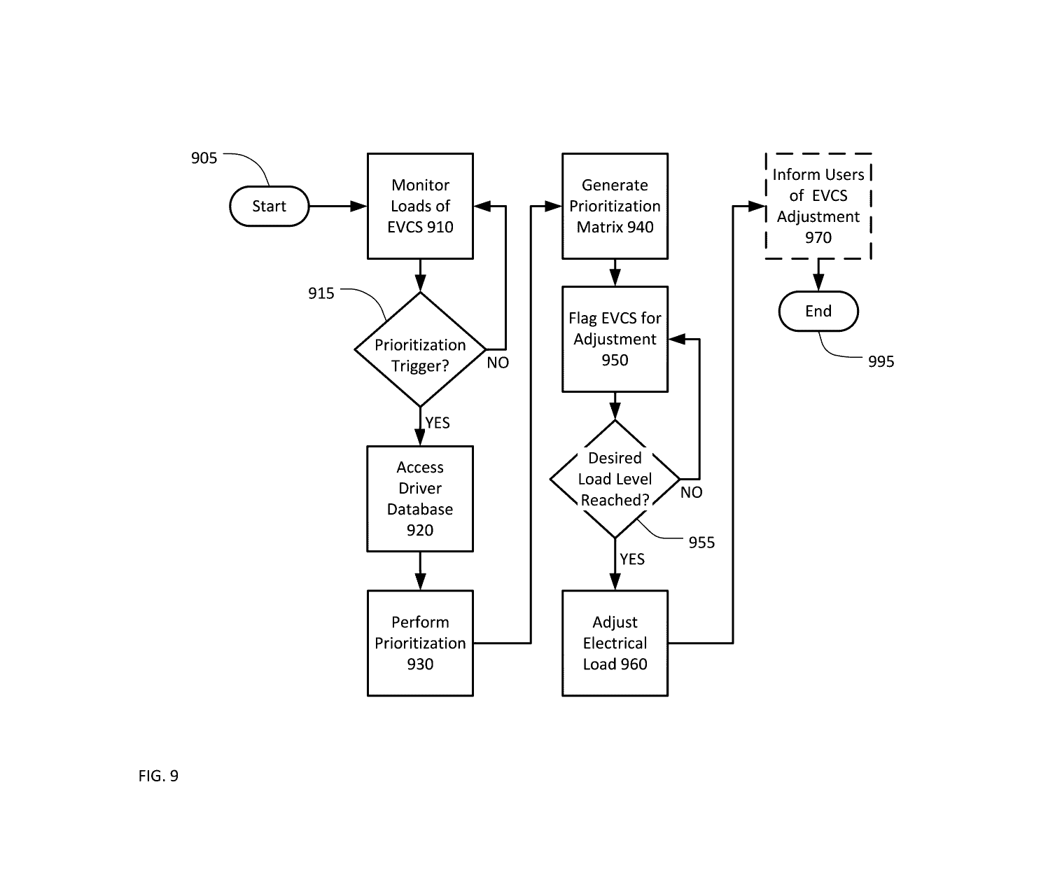

Referring now to FIG. 9, a flowchart of the process of multiple EVCS load adjustment is shown. Although the process is shown with a start 905 and an end 995, the process may be cyclical and may repeat. This process may be used in conjunction with always-on throttling according to a rule, such as those discussed above with respect to FIGS. 7 and 8. Always-on throttling may be the result, for example, of a rule that is applicable at all times regarding one or more EVCS. In spite of any throttling, peak loads may still be reached and managed according to the described process.

The process may repeat at intervals determined by the times, such as peak usage times, during which the cost of electrical service is highest. For example, because electrical service fees are typically highest from approximately 9:00 am to 6:00 pm (or noon to 6:00 pm), the process may repeat each day at 9:00 am. Or, alternatively, the process may begin at 9:00 am (or continue running from 9:00 am until 5:00 pm) to await a prioritization trigger at 915 (discussed below).

This process begins after a start 905, with monitoring the loads drawn by a plurality of EVCS at 910. This process may involve monitoring the electrical draw of a single set of EVCS at a single location serviced by an EVCS management network. Alternatively, this process may involve monitoring the electrical draw of a plurality of EVCS at multiple locations across an entire EVCS cloud of EVCS management networks. The multiple locations may be cities or states apart, drawing power from different power companies with different billing structures. The EVCS may be operated by or on behalf of a single entity (e.g. a corporation's employee parking lots across multiple physical locations may operate several sets of EVCS) or may be a management company that manages multiple EVCS operated or installed at multiple physical locations that are available otherwise unrelated business or governmental entities.

In either case, the overall electrical draw of all EVCS is measured. Typical draw for a single level 1 EVCS is approximately 1.5 kW while typical draw for a single level 2 EVCS is approximately 7.2 kW. Electric utilities charge rates based upon overall power usages (measured in kW h (kilowatt hours)) and peak usage by a consumer (measured in kW as the highest draw of power over a calendar week or month). As a result of this peak load cost basis, consumers have incentive to ensure that this peak load is as low as possible throughout a given period.

At present, the cost at certain peak load levels can be much more expensive per kW than off-peak load costs. For example, the cost per kW can be approximately $25 per kW at peak load where cost per kW at non-peak loads can be $5-10. As such, parties responsible for payment for electrical use of EVCS have a strong incentive to carefully manage peak load in addition to overall kW h of draw. Simultaneously, EVCS management should endeavor not hinder employees' (or other users') ability to travel reasonable distances after use of an EVCS, for example, commuting to and from their homes.

The collective load of the EVCS monitored at 910 can be 1.5 kW times the number of level 1 EVCS added to 7.2 kW times the number of level 2 EVCS. So, for example, an EVCS cloud made up of 40 level 1 EVCS and 20 level 2 EVCS peak draw at full utilization could be 40×1.5 kW or 60 kW added to 20×7.2 kW or 144 kW for a total of 204 kW. The cost of this consumer's peak load at the example peak load rate of $25 a kW is $5,100.

Here, the EVCS cloud monitors the collective peak load in an effort to ensure it remains below an administrator-set predetermined peak load. As used herein, the “predetermined peak load” is a EVCS cloud administrator-set combined electrical draw (e.g. measured in kW or Mw) of a plurality EVCS managed by a single EVCS cloud that may be in multiple locations remote from one another. In particular, “predetermined peak load” is not the load over any time period of a single or many EVCS (e.g. measured in kW h or Mw h) nor is it the current or peak load of a single EVCS (e.g. measured in kW or Mw).

For example, while the managed EVCS cloud may be able to simultaneously provide 204 kW of electricity, the predetermined peak load, set only for peak load times as determined by the electrical utility, may be 140 kW. This monitoring at 910 may be periodic, on the order of hours, minutes, or seconds and may be based upon actual monitoring of electrical draw as determined by sensors or may be estimated based upon the number of EVCS presently in use by PEVs and the specific type of EVCS used by those PEVs.

At 915, a determination is made whether a prioritization trigger has been met. This may occur, for example, when a present draw exceeds a predetermined peak load or when a present draw is about to exceed a predetermined peak load. If the predetermined peak load is not met and no prioritization trigger occurs (“no” at 915), then the process continues with additional EVCS monitoring at 910.

If the prioritization trigger has been met (“yes” at 915), meaning that the present peak draw has exceeded (or met) the predetermined peak load, then the driver database is accessed at 920. This driver database may be, for example, driver database 332 of FIG. 3. The driver database is accessed at 920 in order to obtain data regarding the drivers presently using the EVCS that is serviced by the EVCS cloud.

For example, data pertaining to a car associated with a driver, present battery charge and charge capacity may be obtained from relatively straightforward information about the type of car each driver has connected to each EVCS. More detailed information, which may be input by a driver as a prerequisite to employment at a location, as a prerequisite to EVCS usage at all, or voluntarily, may be used to determine more detailed information such as commute time, typical other driving, any membership in special groups and other information described as stored in the driver database 332 above.

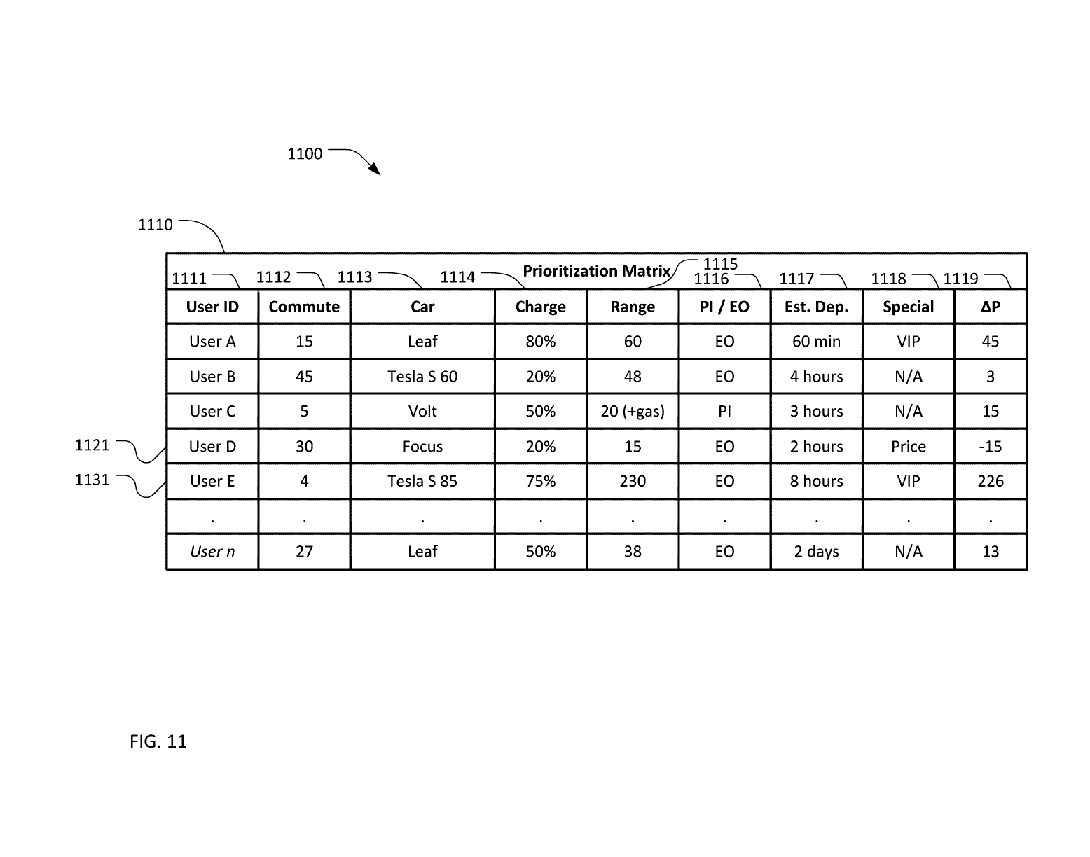

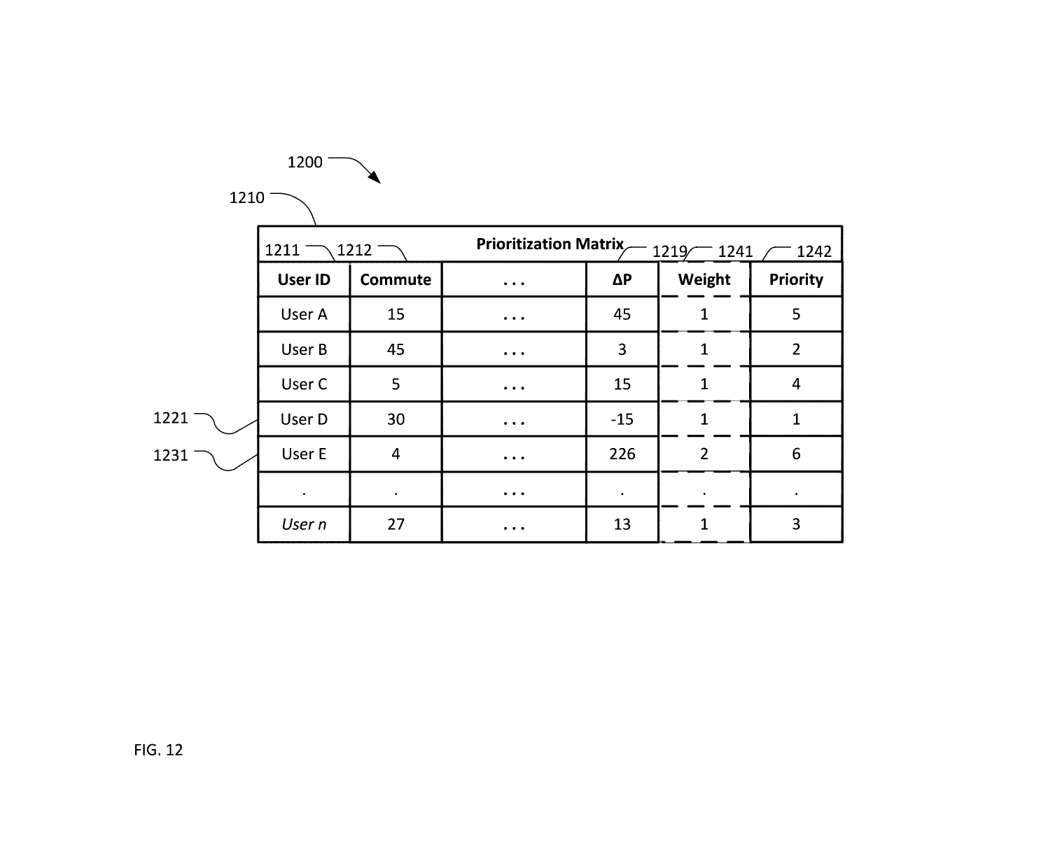

Once that driver database is accessed to obtain driver information at 620, prioritization may be performed. An example prioritization matrix is shown in FIGS. 11 and 12, however various information may be included in such a matrix.

As the prioritization is performed, various comparisons and determinations may be performed. For example, prioritization may always prioritize electric-only vehicles over plug-in hybrid vehicles. This is because electric-only vehicles have no alternative but to rely upon electric power. Second, prioritization may prioritize vehicles based upon a comparison of their available range (made up of a charge percentage times their total range at full charge) to their commute from the present location to a home location (reliant upon the driver database indicating a home location).

Next, prioritization may favor drivers of PEVs that are members of a special group, such as an executive of a business that operates the EVCS or a member of an affinity program or an individual who has proactively indicated a willingness to pay extra to ensure that his or her PEV always receives a charge and/or priority. Prioritization may also prioritize drivers that typically leave earlier (e.g. 3 pm) and, thus, need to receive a completed charge earlier than a more-typical 5 or 6 pm departure time. Prioritization may also favor paying guests of a facility (e.g. hotel or restaurant), visitors to a business (customers or individuals at a business meeting), individuals who have specifically requested an exception for a day or other predetermined time period. Alternatively, prioritization may favor drivers that arrive first with priority over latecomers (e.g. providing a charge until the predetermined peak load is reached, then not enabling any new EVCS until earlier EVCS are vacated).

Still more complex prioritization schemes may weight individual characteristics (e.g. electric-only, special group membership, or fee payment) more heavily than others or more heavily at different times. Other prioritization schemes may employ multiple weighting factors applied to different characteristics such that, for example, the driver with the largest range versus commute difference may be weighted using one factor, while the driver with the lowest state of charge overall is weighted with another factor, and while the driver with membership in a special group is weighted with still another factor.

Applying the prioritization scheme performed at 930 using the driver data obtained at 920, a prioritization matrix may be generated at 940. The matrix may be configurable, as described above, such that the prioritization scheme enables an EVCS cloud administrator to automatically prioritize those drivers as he or she (or the organization as a whole) wishes. The generation of the prioritization matrix at 940 may include the application of any weighting and the generation of Power Differential (ΔP) for each driver, with ΔP defined as Available Range (R)−Commute Distance (C).

Using the prioritization matrix generated at 940, one or more EVCS, of the EVCS managed by the EVCS cloud, may be flagged for adjustment at 950. The flagged EVCS are the EVCS with PEVs presently connected that have been identified, based upon the prioritization matrix and the predetermined peak load, for adjustment. Returning to the example above, if the predetermined peak load is 140 kW and the present load across all EVCS served by the EVCS cloud just reached 155 kW (generating a prioritization trigger at 615), then some of the EVCS will have to be disabled or adjusted to lower the present load. This may mean halting the charge across, for example, two level 2 EVCS or across 10 level 1 EVCS. Alternatively, 3 level 2 EVCS could be reduced to level 1 loads for a reduction in present load of 17.1 kW. This way, all EVCS would still be charging, with only a few at a lower rate of charge. Thus, the adjustment may be complete disablement of charging for a given EVCS or group of EVCS, for example, all EVCS of the same priority. Adjustment may also be merely lowering the load available to one or more EVCS. A combination of disabling and adjustments may also be made to reduce the present load below a predetermined peak load.

As shown in 950, a flag may be placed on those EVCS identified for load adjustment—that is the PEVs (and the associated EVCS) with the lowest overall priority. This flagging may be on a per EVCS basis. At 955, a determination is made whether the desired present load level has been reached. If not (“no” at 955), an additional EVCS may be flagged for adjustment at 950. Once reached (“yes” at 955) the overall electrical load is adjusted at 960. Although shown as an iterative process at 950 and 955, the process may occur substantially instantaneously through rapid comparisons and subtractions of adjusted loads until the desired present load is reached.

Thereafter, at 960, the adjustments to the present electrical load are made to each of the EVCS so as to arrive at a present load below the predetermined peak load. Optionally, the users of the adjusted EVCS may be informed of the adjustment at 970. This may occur, for example, to enable the drivers to request an exception or to ensure that drivers are aware that their charge may not be full when they leave. This process at 970 may take place, for example, via a mobile device, such as a smart phone or tablet or may take place by text message or email. A setting determining the method of contact may be altered as a part of a mobile application or web-based application used by the drivers to provide information that is stored in the driver database. The process may end at end 995.

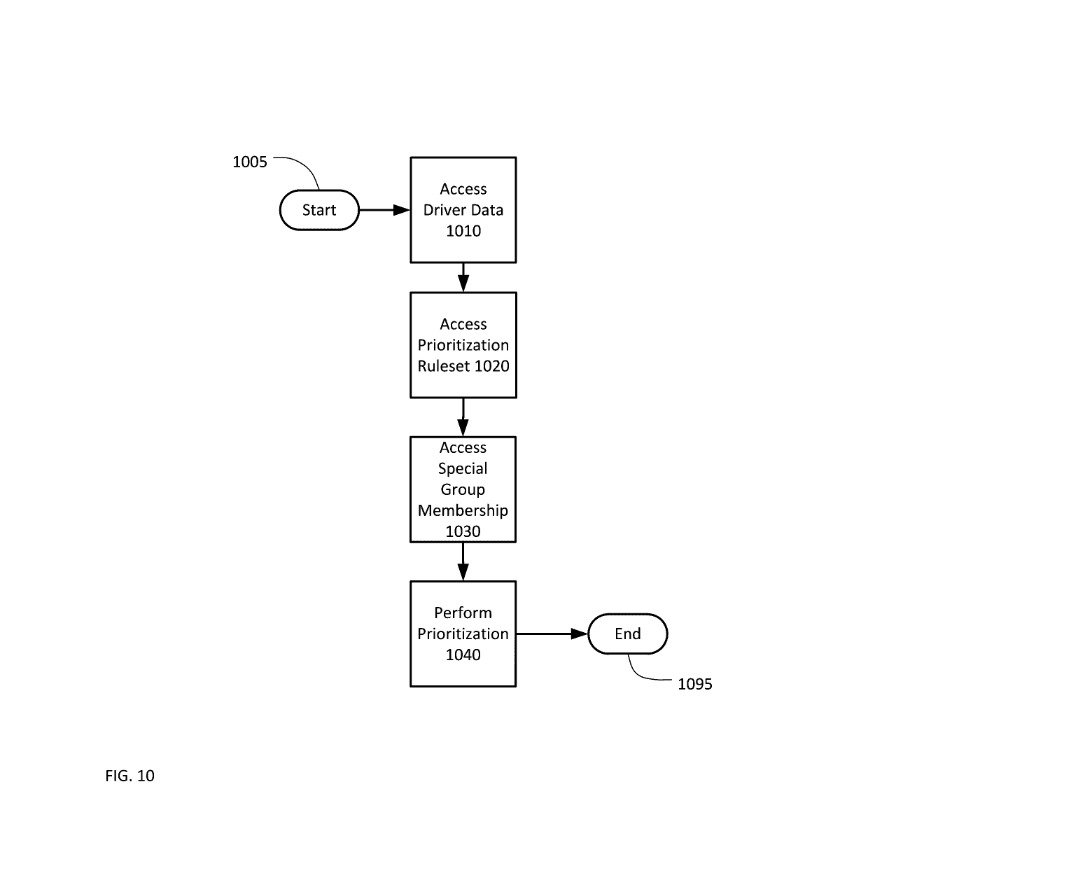

Turning now to FIG. 10, a flowchart of prioritization of EVCS for use in identifying EVCS for load adjustment is shown. This process is an expanded view of the process that takes place at element 930 of FIG. 9. The process begins at start 1005 and ends at end 1095, but may take place many times across multiple EVCS or an EVCS cloud.

After the start 1005, the process begins by accessing the driver data 1010 obtained from a driver database at 920 of FIG. 9. This driver data is accessed at 1010 in order to obtain the data relevant to the prioritization matrix as pre-determined by settings, such as rules, input by an administrator. For example, settings within one EVCS cloud may only consider whether or not an electric vehicle is an employee (e.g. a member of a special group) and may prioritize all employees over non-employees. In such a case, the only driver data that is accessed is employment status.

In other cases, an EVCS cloud may perform a complex prioritization involving a determination of whether or not a vehicle is electric-only or a plug-in hybrid, whether a driver of a PEV has sufficient charge to reach home after he or she leaves the location, whether the driver is the member of a special group, and whether the driver will be leaving in the next hour or many hours from now (prioritizing those drivers who leave soonest over those that leave latest). In this case, a larger set of driver data may be accessed, while ignoring other, available data. In other cases, an entire set of driver data may be obtained, temporarily, and only that data that is relevant may be used.

After the relevant driver data is accessed at 1010, the prioritization ruleset is accessed at 1020. This prioritization ruleset may be updated from time to time by an administrator. The ruleset may indicate those aspects of the driver database that are most important and, therefore, identified as priorities for continuing charging at an EVCS. Similarly, the ruleset may identify PEV and driver aspects that are less-important and more likely to result in a low priority for a given PEV and/or EVCS. So, before generating a prioritization matrix, the updated prioritization ruleset may be obtained, for example, from a database or central server servicing an EVCS cloud.

At 1030, membership in a special group may be accessed. In some cases, the driver database may be system or Internet-wide, for example, if a driver is a member of a third party website or overarching management system that enables access to a plurality of related and unrelated EVCS systems. In such a case, the driver may be an employee of one of an operator of one of the EVCS systems, but not of the vast majority of EVCS systems managed by the EVCS cloud. As a result, membership in a special group, such as an executive at a company or an employee of a specific company may be stored in a separate database. Or, alternatively, maybe stored in the same overarching database, but may be stored in such a way that the EVCS cloud must confirm ownership or management of a particular EVCS or group of EVCS in order to determine if a driver is a member of a special group affiliated with a given EVCS.

For example, the EVCS cloud may manage hundreds of EVCS spread across a large geographic area. Ten of those EVCS may be located at a company which employs hundreds of individuals, of which, thirty have PEVs of some type. The drivers of those PEVs may register with the EVCS cloud, but may only have special group membership as employees of the company at the ten of those EVCS that are located at a company. In such a case, the EVCS cloud will confirm special group membership on two fronts, both that the driver is an employee and that the EVCS being accessed is an EVCS at which the driver has special group membership privileges. This process occurs at 1030.

Once these three data sets are obtained at 1010, 1020 and 1030, the prioritization may be performed at 1040. At this stage, all of the data is gathered and the drivers are prioritized according to the data and the ruleset determined by a given administrator. Rulesets may apply across an entire EVCS cloud or only on subsets of an EVCS cloud, for example, those EVCS of the EVCS cloud owned and operated by a particular company. Still further, overarching rulesets may be established, with sub-rulesets applicable only to a subset of the EVCS (e.g. those owned or operated by a specific company or group). Here, the prioritization process ends at 795.

After the prioritization is performed, the prioritization matrix is generated (see element 940 in FIG. 9).

FIG. 11 is a prioritization matrix 1100 for use in prioritizing vehicles across multiple EVCS. This is a prioritization matrix 1100 prior to generating prioritization showing example driver data that may appear in such a prioritization matrix 800. The data shown in the prioritization matrix 1100 may be drawn, for example, from the driver database 332 (FIG. 3) at step 920 (FIG. 9).

The prioritization matrix 1100 includes a header 1110 identifying it as a prioritization matrix and a series of column labels. The column labels include user ID 1111, commute 1112, car 1113, charge 1114, range 1115, PI/EO (plug-in/electric only) 1116, estimated departure 1117, special 1118, and ΔP (power differential) 1119.

The user ID 1111 may be a unique identifier associated with a particular driver and/or a particular PEV. In the vast majority of cases, the user ID 1111 will identify a single driver and a single PEV associated with that driver. In some unusual cases, a driver may have more than one PEV and, thus, may have multiple user IDs 1111.

The commute 1112 is shown in miles as the distance, after the driver leaves, that the PEV must travel before another charge will be available. This commute 1112 may be stored in the driver database as a number (e.g. in miles or kilometers) or may be stored as an address, such as a home address. When a home address is stored, then the commute may be calculated automatically as a prioritization matrix 1100 is populated with data based upon the EVCS which the PEV is accessing.

If the commute 1112 is stored as an address, this may enable the EVCS cloud to calculate a given commute no matter what EVCS across a large network of geographically different EVCS. For example, a driver may access an EVCS at work regularly, but may periodically access an EVCS at a large client 30 miles further from his or her home. In such a case, the typical “commute” stored in miles or kilometers would be incorrect. As such, storing the address to which a driver (and/or PEV) must travel and calculating a commute based upon that address and the physical location of the EVCS may be preferable.

Next, the car 1113 identifies the make, model and year of PEV that is associated with the user ID 811. These are shown in the prioritization matrix 1100 as merely the “Leaf,” “Tesla S 60,” and the like, but more detail may be available. Based upon the make, model, and year, detailed information on battery size, battery storage, methods for interacting with the PEV (e.g. to obtain information about charge and rate of charge), range, maximum charge, and various other data about a specific PEV may be ascertainable.

Similarly, historical data about a particular PEV associated with a user ID 1111 may be stored in association with that user ID 811 so as to indicate, for example, that a particular PEV is only capable of 90% of its original range due to battery degradation over time. This data may also be estimated based upon the year and original battery size and type determined based upon the car 1113 identified.

The charge 1114 is the present available charge of the PEV associated with a particular user ID 1111. The charge may be expressed in a measurement of charge, such as A h (ampere-hours), or may be expressed in a time-unit of charge available, or may be expressed as a percentage of full charge, or may be expressed directly as a range available, given a specific level of charge.

The range 1115 is the distance that may be travelled, given the present level of charge 1114. The range 1115 may be directly reported by a user or may be obtained based upon the charge 1114. For example, the range may be default range multiplied by a percentage of charge, either reported by the PEV or by the driver or estimated).

The PI/EO (plug-in/electric-only) is a flag indicating whether or not a vehicle is a plug-in hybrid (capable of operating on a gas engine) or an electric-only vehicle (capable only of operation using battery power).

The estimated departure (Est. Dep.) 1117 is an indication of a typical (drawn from a history of departures) or self-reported time of departure for the PEV. The estimated departure 1117 may be expressed as a time (e.g. 3:00 pm) or a time-until (e.g. 60 minutes).

The special 1118 category identifies any group memberships, special payment options and the like with which the user ID 1111 is associated.

The ΔP (power differential) 1119 is an estimate of the difference between the available range and the commute. If the difference is negative, for example, this indicates that the driver of the PEV may not be able to make it through the commute at the end of his or her day. If the difference is small, this may indicate that the driver of the PEV may have difficulty (for example if there are high winds or many uphill roads on the way to his or her home) completing a commute. A high number for the ΔP (power differential) 1119 indicates that the driver is unlikely to have any difficulty reaching home and that the charge is very likely sufficient to complete the commute home.

Example user IDs 1121 and 1131 showing users D and E, respectively, are shown. As can be seen from the prioritization matrix 1100, much information about each driver may be included. However, user D 1121 and user E 1131 are singled out as extreme examples of a few driver characteristics.

User D 1121 has a charge of only 20% and a commute of 30 miles. User D 1121's car is a Ford Focus with a fully-charged range is approximately 75 miles and is electric only. So, a charge of only 20% indicates that User D 1121 has only approximately a 15 mile range. As a result, user D's ΔP is −15. This indicates that user D 821 will likely fall 15 miles short of reaching his or her destination when he or she leaves the EVCS unless his or her PEV receives a charge. Even more, user D 1121 estimated departure is 2 hours. Thankfully, user D 1121 is aware of his or her need for charge and has agreed to pay extra as indicated in the price column. As a result of all of this, user D 1121 is a high priority PEV for receiving a charge.

In contrast, user E 131 has a commute of only 4 miles and drives a car that is a Tesla S 85. User E 1131 has 75% charge of a total range of approximately 306 miles. Thus, the present range is 230 miles and the Tesla S 85 is electric only. Further, user E 1131 estimated departure is 8 hours from now and the driver is a “VIP” (e.g. an executive, an important visitor, or some other special status entitling he or she to special consideration when charging). As a result of the above, user E's ΔP is 226, by far the largest of anyone in the prioritization matrix 1100. This means that given user E's 1131 4 mile commute and 230 mile range, user E 1131 is very, very likely to reach his or her home before completely exhausting his or her present charge.

FIG. 12 is a prioritization matrix 1200 showing priority for vehicles. This prioritization matrix 1200 is substantially similar to the prioritization matrix 1200 of FIG. 11. The same header 1210, user id 1211, commute 1212, and ΔP 1219 are shown. User D 1221, user E 1231 are also identified.

However, in FIG. 12, a weighting 1241 and priority 1242 are also shown. A special weighting may be applied to some users or particular characteristics associated with a particular user ID. Here, user D 1221 has no special weighting (a weighting of 1 indicates 100% weighting in this case) applied to his or her priority. Thus, user D 1221's ΔP of −15 makes user D have the highest priority (as indicated by the “1”).

In contrast, user E 1231 with the ΔP of 226, and with a weighting of 2 (indicating double-weight, for example, because user E 1231 is a “VIP”) has very little effect on user E 1231's priority because user E 1231 has such a large ΔP. This may be applied, for example, by dividing user E 1231's ΔP by 2 to thereby double its potency. This results in a weighted ΔP of 113, which is still larger than any other user. As a result, user E 1231's priority is 6 out of the visible six users.

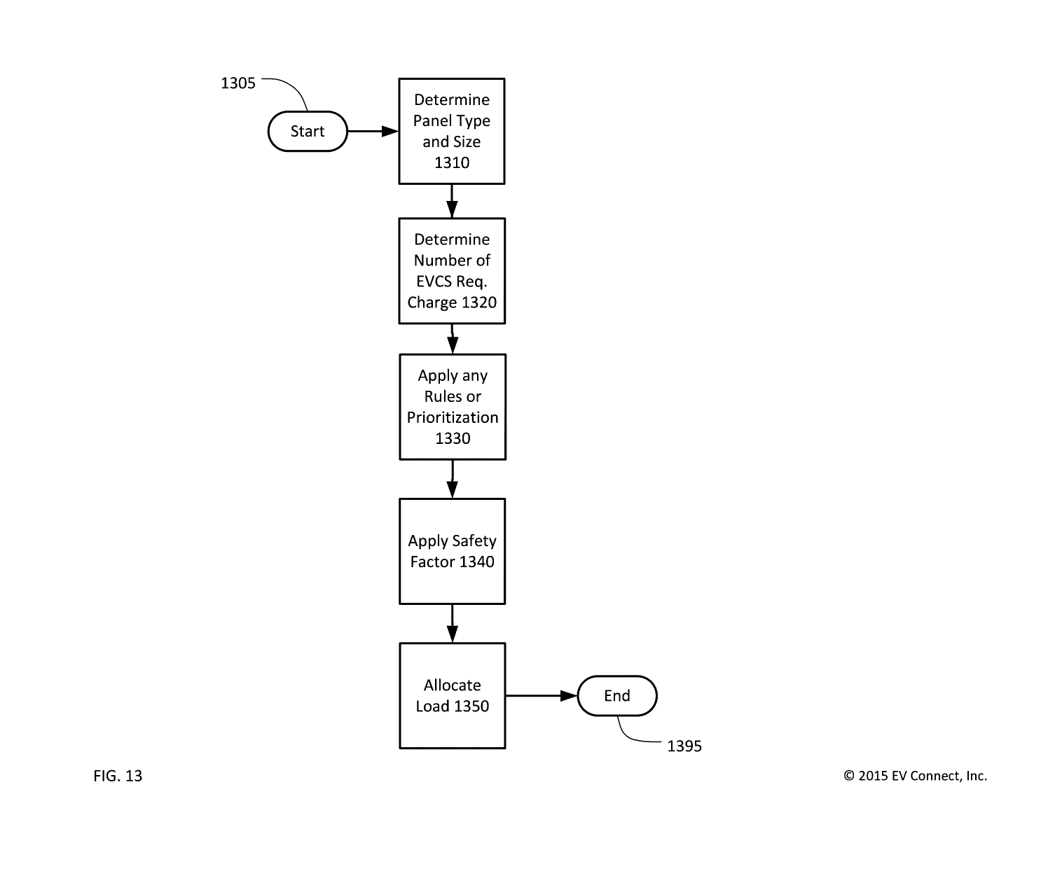

Turning to FIG. 13, a flowchart for load sharing on single or multi-phase EVCS panels is shown. The flowchart has a start 1305 and an end 1395, but may take place as new EVCS are added to an EVCS cloud or as EVCS become unavailable to an EVCS cloud (e.g. are uninstalled or are disabled for any reason). In this way, the load may be shared appropriately for a group of EVCS making up part of an EVCS cloud.

First, the panel size and type may be determined at 1310. This may be done, for example, by the server 240 (FIG. 2). At this stage, the server managing the EVCS cloud may use discovery algorithms, self-reported information about a panel or panels, or information related to the load available and draw being taken to determine the type and size of a panel supporting one or more EVCS in the EVCS cloud. This process may include determining or otherwise obtaining information related to the panel size (in amperes), any reserved load on the panel (e.g. loads that the panel may not provide to other circuits thereby decreasing the available load), the number of EVCS connected to the panel, which circuit breaker is associated with each EVCS (or EVCSes), the maximum current that may be supported on the panel, and any active legs (those functioning) for three-phase panels. This information is used to safely and accurately throttle EVCS connected to the panel.

Next, the number of EVCS that are requesting a charge is determined at 1320. This may be done, for example, by a server 240 (FIG. 2). This process may also include identifying the number of EVCS that may request current from the panel.

Next, any rules of prioritization may be taken into account at 1330. This is done to ensure that priority users, for whatever reason, may still be prioritized as the load is managed. In some cases, this may mean that larger portions of the available load for a given panel may be allocated to a particular EVCS or PEV through an EVCS than would otherwise be allocated. This may result in other EVCS or PEVs being throttled to a greater degree than they might otherwise be.

Next, a safety factor is applied to the load for a panel (or leg) at 1340. For each phase, an additional 25% of load must be available as a reserve to ensure safety. For a single phase panel, this means the load must leave an additional 25% safety factor on that single phase. For three phase panels, this means that the load on each bridged leg must maintain this same 25% safety factor.

Once all the information is obtained, the load may be allocated at 1350. This process takes place differently for a single phase panel and a three phase panel as described below.

For a single phase panel, the variables I_{P} is panel size, measured in amps, I_{R} is reserved load for other circuits, measured in amps, I_{A} is available remaining load on the panel, measured in amps. Finally, the factor of safety is F_{S}. Thus, the resulting I_{A} (available load) is I_{A}=I_{P}−I_{R}*F_{S}. The F_{S} is 1.25 in this expression based upon the electrical code.

Next, E is an EVCS number (from 1 to n), I_{BE} is a breaker size for the circuit powering the EVCS, measured in amps, I_{E} is the EVCS rating, measured in amps, and I_{r,E} is the requested load by the EVCS E, measured in amps. The I_{r,E} is presumed to be equal to the EVCS raiting I_{E}, multiplied by the safety factor F_{S}. Thus, the total requested load by all active EVCS (I_{r,T}), measured in amps, may be expressed as:

I_{r,T}=Σ_{E,active}I_{r,E}

The throttle for EVCS E (TE) such that TE=100 (zero throttle—100% of requested load) when the total requested load (Ir,T) is less than the available load (IA). However, when the requested load is greater than the available load (I_{r,T}>I_{A}), then the throttle for a single phase panel can be calculated as T_{E}=I_{A}/I_{r,T}. Thus, every station connected to the panel is throttled by the same T_{E} value, because they are all supported by the one single phase panel with the available load I_{A}.

Three phase panels have three legs, A, B, and C. These legs are shown, for example, in FIG. 5. As also described with respect to FIG. 5, the legs may be bridged into legs AB, BC, and CA, if additional amps are required. As loads are drawn by one or more EVCS, the loads on each leg preferably be balanced such that the first load will be serviced by leg AB, the second load by leg BC and the third load serviced by leg CA. The fourth load will be serviced by leg AB and so on. As power draw increases, the loads must be balanced so as not to exceed the available load of the panel as a whole (or of each leg).

Typical panels are 120/208 Volt “Y” configuration panels. The Y type panels are called Y panels because the three voltage sources are connected at a single point, sharing a single common fourth connection to a neutral line. The resulting circuit drawing appears as a “Y” when viewed. Typically a 120-degree phase shift exists between the three legs of the Y. The 120 volts is the voltage from the neutral to any one leg. 208 volts is the voltage between any two legs.

The panel size may vary in amps, providing, for example, 100 A, 225 A, 400 A, 600 A or similar sizes. The existing loads on each of the legs A, B and C are taken into account. In addition, for each EVCS, the legs used by the EVCS (AB, BC, and/or CA), the circuit breaker size for the EVCS, measured in amps, the maximum load for the EVCS, measured in amps, and the vehicle load on the EVCS. The vehicle load may be static, the maximum load rating of the EVCS or, alternatively, may be dynamic based upon the type of vehicle (and associated charging equipment) connected to the EVCS circuit.

Taking these aspects of the panel, circuit and loads into account, they are provided with the following variable names. Iₚₐₙₑₗ is the panel size in amps, I_{res,x} is the reserved load on a leg of the panel where x=A, B, or C, measured in amps. I_{avail,x} is the available load on a leg of the panel where x=A, B, or C, measured in amps. E is the EVCS number (from 1 to n). I_{req,x} is the requested load on a leg where x=A, B, or C, measured in amps. I_{req,x,ε} is the requested load on a leg by EVCS ε, measured in amps. Iₘₐₓ is the maximum load on a circuit or EVCS rating, measured in amps. Iᵥₑₕ is the maximum vehicle load it can accept in amps. F_{S} is the factor of safety of 1.25. T_{A} is the throttle value applied to leg A, T_{B} is the throttle value applied to leg B, and T_{C} is the throttle value applied to leg C. Finally, I_{del,x,ε} is the delivered load on leg x by EVCS E, measured in amps.

The Iᵣₑₛ for each leg may be may be a static value provided by an electrician and includes the sum of any reserved or preexisting loads on each of the legs A, B, and C. The reserved loads do not include any factor of safety, so to determine the I_{avail,A}, I_{avail,B}, and I_{avail,C}, the factor of safety must be applied. This may be done in the form:

I_{avail,x}=Iₚₐₙₑₗ−I_{res,x}*F_{S}

This may be performed for each panel to determine the associated I_{avail,x} for each panel.

The load requested by an EVCS may be either (1) the maximum draw of the PEV based on the load rating of its on-board battery charger or (2) the maximum draw of the station based upon its power rating. If the maximum draw of the PEV exceeds the EVCS power rating, then the lower value of the EVCS power rating will control because the EVCS cannot handle the vehicle's maximum draw. If the maximum draw is the same or lower than the EVCS power rating, then the maximum draw of the PEV will control.

By way of an example, a Chevrolet Volt has an on-board battery charger than is rated at 3.3 kW. If the Volt is connected to a standard level 2, 30 A station, then it will draw a maximum of 15.8 A (3.3 kW/208V). In this case, the requested load I_{req} is 15.8 A. Contrast that with a Tesla Model S with an on-board battery charger rated at 10 kw. If the Model S is connected to the same standard level 2, 30 A station, it will seek to draw 48 A (10 kW/208V). However, it will be limited by the draw available to the level 2, 30 A station of 30 A. Thus, the I_{req} for the Model S is 30 A.

In either case, for the EVCS to achieve the 208V, the EVCS must bridge two of the three legs (or phases) of the panel. The bridged legs may be called AB, BC, or CA. However, a load applied to a bridged leg applies to both legs. As a result, a circuit that bridges A and B would create an identical load on both leg A and leg B. So, for the Volt described above that provides a load of 15.8 A on a level 2, 30 A station, the 15.8 A would apply equally to both leg A and leg B of a bridged leg AB.

All existing loads must be summed for each leg, and must not exceed the panel rating on an individual leg. The sums may be expressed as:

I_{req,x}=Σ_{ε=1}ⁿI_{req,x,ε}

Where “x” is the leg, A, B, or C for which the load is being summed. If the requested load I_{req,x} multiplied by the factor of safety F_{S} on each leg are less than the available load I_{avail,x} then no throttling of the load is required and all EVCS using the leg may receive the maximum requested current. This may be expressed as:

If: I_{req,x}≧I_{req,x}×F_{S}

then: Tₓ=1.00(no throttling)

However, if any of the requested loads exceed the panel rating (for a leg), then the loads on the leg(s) that exceed the panel rating must be throttled. The throttling value may be calculated as:

$$If \text{:} {I}_{avail , x} < {I}_{req , x} \times {F}_{s}$$

$$then \text{:} {T}_{x} = \frac{{I}_{avail , x}}{{I}_{req , x} \times {F}_{s}}$$

As indicated above, bridged legs must be throttled according to the maximum load on each leg independently. Then, if the legs are bridged, the same throttle must be applied to each leg. Thus, to properly throttle, for example, legs A and B which have been bridged, the appropriate throttle T_{leg,AB} is:

T_{leg,AB}=Min{T_{A},T_{B}}

All of the EVCS that rely upon either leg A or leg B must be throttled by this throttle value T_{leg,AB}. Those legs that rely upon C and the bridge legs BC and CA may have a different throttle value T.

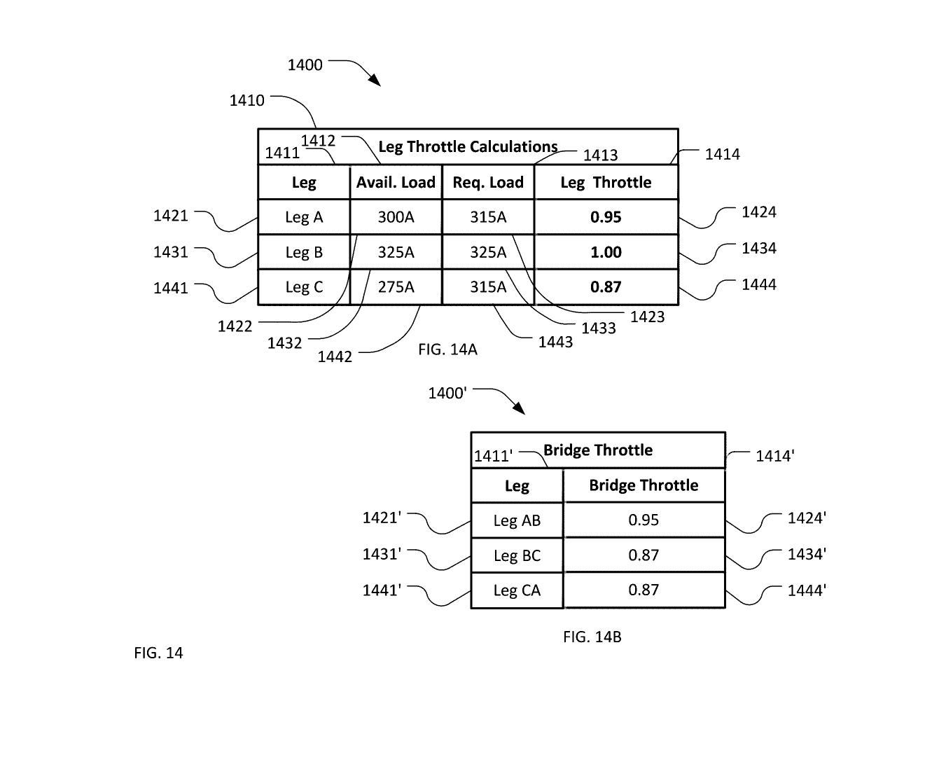

Referring briefly to FIG. 14, made up of FIGS. 14A and 14B, calculations related to load sharing are shown. FIG. 14A is a table 1400 showing shows calculations 1410 related to particular legs being shared, where FIG. 14B is a table 1400′ showing the throttle applied to each bridged leg 1421′, 1431′, and 1441′ based upon the calculations of FIG. 14A. As can be seen, table 1400 includes a column for legs 1411, one for available load 1412, one for requested load 1413 and one for leg throttle 1414. There are three legs A 1421, B 1431 and C 1441. When numbers repeat between FIG. 14A and FIG. 14B but include a “′”, they serve the same function, but are identified independently for ease of reference.

AS may be seen in the available loads 1422, 1432, and 1442, FIG. 14 presupposes a three phase service panel with a rating of 400 A that has the following available loads:

I_{avail,A}=300 A I_{avail,B}=325 A I_{avail,C}=275 A

Further, as can be seen in the requested loads 1423, 1433, and 1443, based on the EVCS circuits, the requested load on the three legs are:

I_{req,A}=315 A I_{req,B}=325 A I_{rec,C}=315 A

Using the throttle equations for an individual leg as set forth above and based on these requested loads, the throttling values 1424, 1434, and 1444 can be calculated as:

T_{A}=0.95 T_{B}=1.00 T_{C}=0.87 A

Because the throttle applied to any individual leg must also be applied to any bridged leg, the bridged leg throttling 1414′ values 1424′, 1434′, and 1444′ are derived as:

T_{leg,AB}=0.95 T_{leg,BC}=0.87 T_{leg,CA}=0.87 A

Each of the component loads that make up I_{req,A,ε}, I_{req,B,ε} and I_{req,C,ε} are throttled by the factor applicable to the legs which they span. For example, because T_{leg,BC} and T_{leg,CA} both span leg C, the throttling applied to leg C T_{C} applies to both. Therefore, the throttling applied to both BC an CA is 0.87, even though the throttle applied to leg B is 0% (T_{B}=1.00). The throttling of bridged legs reduces the individual loads on each leg proportionately and thereby reduces the aggregate load on each leg to safe levels.

As discussed above with respect to 1330 in FIG. 13, prioritization may also be applied in conjunction with the throttling and load balancing that takes place. The prioritization may be based upon group membership (executive, paying member, etc), first come, first served, pay for play (a willingness to pay extra to be prioritized), and/or need (if a charge is not received, the PEV may not make it to its next destination without requiring a recharge).

To perform prioritization, each load may be prioritized, for example, with a priority of 1 to 5 with 1 being the highest. Next, the loads with the same priority (first starting with 1) are summed across all three legs, as

I_{req,x}=Σ_{ε=1}ⁿI_{req,x,ε}

Next, the total loads of that same priority (e.g. priority 1) are less than the total available power, then all of the circuits with that priority (e.g. 1) are supplied with the full requested amperage. The new value of available load is calculated as:

I′_{avail,A}=I_{avail,A}−I_{req,A,P}*F_{S}

Where P is the priority (e.g. 1) of the priority level being subtracted from the available load. Next, the process is repeated for the next lower priority (e.g. priority level 2) until the total requested load for a particular priority level is greater than the available remaining load on all three phases.

Once the loads of a priority exceed the available power for all three phases, then throttling values are calculated using the equation:

$$If \text{:} {I}_{avail , x} < {I}_{req , x} \times {F}_{s}$$

$$then \text{:} {T}_{x} = \frac{{I}_{avail , x}}{{I}_{req , x} \times {F}_{s}}$$

Where X is the leg for which a throttle value (T_{X}) is being calculated. The throttling is applied to all requested loads in a particular priority. The available load for each leg is re-calculated as:

I′_{avail,A}=I_{avail,A}−I_{req,A,P}*F_{S}

Where P is the priority (e.g. 1) of the priority level being subtracted from the available load. The process may be repeated if there is any available load remaining on any leg until there are no longer any charging possibilities based upon the requested load and the rating of the panel and/or EVCS.

### CLOSING COMMENTS

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. An electric vehicle charging system comprising:
multiple electric vehicle charging stations, each suitable for charging at least one electric vehicle; and
a computing device for:
determining that a present load exceeds a predetermined peak load, the present load made up of the combined present loads of the multiple electric vehicle charging stations,
identifying at least two of the multiple electric vehicle charging stations for adjustment of an electrical load, and
adjusting the electrical load of the at least two of the multiple electric vehicle charging stations to arrive at an adjusted load across the multiple electric vehicle charging stations, such that the adjusted load is less than the predetermined peak load.

2. The system of claim 1 wherein the computing device is further for:
generating a prioritization matrix for the multiple electric vehicle charging stations based upon individual characteristics of vehicles receiving a charge from each of the multiple electric vehicle charging stations, and
wherein the adjusting of the electrical load of the at least two of the multiple electric vehicle charging stations is according to the prioritization matrix.

3. The system of claim 1 wherein, when the at least two of the multiple electric vehicle charging stations operate on a three phase panel, the adjustment includes calculating an independent throttle amount for each of three bridges of the three phase panel is the lesser of a highest safe voltage that each independent leg a bridged leg can support.

4. The system of claim 1 wherein the predetermined peak load varies dependent upon a selected one or both of (a) time of day and (b) rates charged to an operator of the multiple electric vehicle charging stations for electrical power.

5. The system of claim 1 wherein the adjusting comprises a selected one of: (a) adjusting the maximum load drawn by the at least two of the multiple electric vehicle charging stations, and (b) disabling the at least two of the multiple electric vehicle charging stations.

6. The system of claim 1 wherein the predetermined peak load is spread across multiple EVCS in distinct physical locations.

7. The system of claim 2 wherein the individual characteristics include at least one of: (a) a make of each vehicle, (b) a model of each vehicle, (c) a year of each vehicle, (d) a battery size of each vehicle, (e) whether each vehicle is electric-only or a plug-in hybrid, (f) a commute distance from the electric vehicle charging station to a vehicle operator's home, (g) additional distances travelled by the vehicle operator on a regular basis, (h) a typical arrival time of each vehicle, (i) a typical departure time of each vehicle, (j) a present state of charge for each vehicle, (k) a present rate of charge for each vehicle, (l) association with an account indicating membership in a special group, and (m) association with an account willing to pay additional fees for continued electric vehicle charging.

8. The system of claim 7 wherein the prioritization matrix prioritizes continuing electric vehicle charging for electric vehicles that are (a) electric-only, and (b) have a state of charge insufficient to enable the electric vehicle to travel an associated commute distance.

9. The system of claim 8 wherein the prioritization matrix further prioritizes continuing electric vehicle charging for vehicles with a typical departure time earlier than typical departure times of others of the vehicles.

10. The system of claim 7 wherein the prioritization matrix prioritizes electric vehicle charging for vehicles that are weighted more heavily based upon association with a selected one of membership in a special group and willingness to pay additional fees for continued electric vehicle charging.

11. A method for charge prioritization to manage peak electrical load across multiple electric vehicle charging stations comprising:
determining that a present load exceeds a predetermined peak load, the present load made up of the combined present loads of the multiple electric vehicle charging stations;
generating a prioritization matrix for the multiple electric vehicle charging stations based upon individual characteristics of vehicles receiving a charge from the multiple electric vehicle charging stations;
identifying at least two of the multiple electric vehicle charging stations for adjustment of an electrical load; and
adjusting the electrical load of the at least two of the multiple electric vehicle charging stations according to the prioritization matrix to arrive at an adjusted load across the multiple electric vehicle charging stations, such that the adjusted load is less than the predetermined peak load.

12. The method of claim 11 further comprising:
generating a prioritization matrix for the multiple electric vehicle charging stations based upon individual characteristics of vehicles receiving a charge from each of the multiple electric vehicle charging stations, and
wherein the adjusting of the electrical load of the at least two of the multiple electric vehicle charging stations is according to the prioritization matrix.

13. The method of claim 11 wherein, when the at least two of the multiple electric vehicle charging stations operate on a three phase panel, the adjustment includes calculating an independent throttle amount for each of three bridges of the three phase panel is the lesser of a highest safe voltage that each independent leg a bridged leg can support.

14. The method of claim 11 wherein the predetermined peak load varies dependent upon a selected one or both of (a) time of day and (b) rates charged to an operator of the multiple electric vehicle charging stations for electrical power.

15. The method of claim 11 wherein the adjusting comprises a selected one of: (a) adjusting the maximum load drawn by the at least two of the multiple electric vehicle charging stations, and (b) disabling the at least two of the multiple electric vehicle charging stations.

16. The method of claim 1 wherein the predetermined peak load is spread across multiple EVCS in distinct physical locations.

17. The method of claim 12 wherein the individual characteristics include at least one of: (a) a make of each vehicle, (b) a model of each vehicle, (c) a year of each vehicle, (d) a battery size of each vehicle, (e) whether each vehicle is electric-only or a plug-in hybrid, (f) a commute distance from the electric vehicle charging station to a vehicle operator's home, (g) additional distances travelled by the vehicle operator on a regular basis, (h) a typical arrival time of each vehicle, (i) a typical departure time of each vehicle, (j) a present state of charge for each vehicle, (k) a present rate of charge for each vehicle, (l) association with an account indicating membership in a special group, and (m) association with an account willing to pay additional fees for continued electric vehicle charging.

18. The method of claim 17 wherein the prioritization matrix prioritizes continuing electric vehicle charging for electric vehicles that are (a) electric-only, and (b) have a state of charge insufficient to enable the electric vehicle to travel an associated commute distance.

19. The method of claim 18 wherein the prioritization matrix further prioritizes continuing electric vehicle charging for vehicles with a typical departure time earlier than typical departure times of others of the vehicles.

20. The method of claim 17 wherein the prioritization matrix prioritizes electric vehicle charging for vehicles that are weighted more heavily based upon association with a selected one of membership in a special group and willingness to pay additional fees for continued electric vehicle charging.
